(19) United States
(12) Patent Application Publication
(10) Pub. No.: US 2016/0178478 A1
(43) Pub. Date: Jun. 23, 2016

(54) DEVICE & METHOD FOR TESTING AN ACOUSTIC EMISSION SENSOR

(71) Applicant: AKTIEBOLAGET SKF, Göteborg (SE)

(72) Inventor: Joseph ERSKINE, Falkirk (GB)

(73) Assignee: Aktiebolaget SKF, Göteborg (SE)

(21) Appl. No.: 14/907,412

(22) PCT Filed: Sep. 13, 2013
(86) PCT No.: PCT/EP2013/068976

§ 371 Date: Jan. 25, 2016

(51) Int. Cl. G01M 13/04; G01N 29/14

(52) U.S. Cl. CPC G01M 13/045; G01N 29/14

(57) ABSTRACT

A device for testing an acoustic emission sensor, the device being configured to monitor a bearing. The device comprises a signal generator and is a portable device that is arranged to be non-permanently attached to a surface of the bearing so that at least a part of the signal generator is pressed against the surface of the bearing.

### CROSS REFERENCE TO RELATED APPLICATION

This is a United States National Stage Application claiming the benefit of International Application Number PCT/EP2013/068976 filed on 13 Sep. 2013, which is incorporated herein by reference in its entirety.

### TECHNICAL FIELD

The present invention concerns a device and method for testing an acoustic emission sensor that is configured to monitor a bearing.

### BACKGROUND OF THE INVENTION

Rolling-element bearings are often used in critical applications, wherein their failure in service would result in significant commercial loss to the end-user. It is therefore important to be able to monitor a bearing so that the residual life of a bearing may be predicted in order to plan intervention in a way that avoids failure in service, while minimizing the losses that may arise from taking the machinery in question out of service to replace the bearing.

The residual life of a rolling-element bearing is generally determined by fatigue of the operating surfaces as a result of repeated stresses in operational use. Fatigue failure of a rolling element bearing results from progressive flaking or pitting of the surfaces of the rolling elements and of the surfaces of the corresponding bearing races. The flaking and pitting may cause seizure of one or more of the rolling elements, which in turn may generate excessive heat, pressure and friction.

In order to improve maintenance planning, it is common practice to monitor the values of physical quantities related to vibrations and temperature to which a bearing is subjected in operational use, so as to be able to detect the first signs of impending failure. This monitoring is often referred to as “condition monitoring”.

Condition monitoring brings various benefits. A first benefit is that a user is warned of deterioration in the condition of the bearing in a controlled way, thus minimizing the commercial impact. A second benefit is that condition monitoring helps to identify poor installation or poor operating practices, e.g., misalignment, imbalance, high vibration, etc., which will reduce the residual life of the bearing if left uncorrected.

An acoustic emission (AE) sensor can be used to monitor a bearing. An AE sensor may namely be used to detect high-frequency stress waves (i.e. waves with a frequency of 20 kHz-3Mz, preferably 100-500 kHz or higher) which accompany the sudden displacement of small amounts of material in a very short period of time. In bearings, vibrations or high frequency stress waves can be generated when impacting, fatigue cracking, scuffing or abrasive wear occurs. The frequency of the stress waves depends on the nature and material properties of the source. Due to the dispersion and attenuation of the vibrations or high frequency stress wave packet, it is desirable to locate a sensor as near to the initiation site as possible. A sensor may therefore be placed in the vicinity of, or on the bearing inner ring or outer ring, preferably in the load zone.

Furthermore, a lubrication film can be compromised by excessive load, low viscosity of the lubricant or contamination of the lubricant with particulate material, or a lack of lubricant. If a lubrication film is compromised in this way, high frequency waves will be emitted by rolling contact of the bearing. The condition of the lubrication film can therefore be assessed by detecting vibrations or high-frequency stress waves that propagate through the bearing rings and the surrounding structure in the event of a breakdown of the lubrication film.

An AE sensor is usually tested on site by mechanically stimulating a high frequency stress wave generated by the bearing, namely by hitting the bearing or bearing housing with a tool, such as a spanner, which causes an acoustic event, and analyzing the signal picked up by the AE sensor. Alternatively, an AE sensor may be tested on site by inducing an acoustic signal into the bearing or bearing housing using a signal generator which is coupled to the bearing using acoustic couplant gel, grease or oil in order to improve the transmission of acoustic signals between the signal generator and the bearing or bearing housing. The surface of a bearing is namely not completely flat and any gaps or imperfections between the surfaces of the signal generator and the bearing surface may impede the transmission of acoustic signals emitted therebetween which thereby reduces the accuracy and reliability of the analysis of signals from the AE sensor being tested. There are other test methods but these are more applicable to be used in laboratories of test and research facilities.

### SUMMARY OF THE INVENTION

An object of the invention is to provide an improved device for testing an acoustic emission (AE) sensor that is configured to monitor a bearing.

This object is achieved by a device that is portable i.e. the device is small and light enough to be carried by a person, using one hand only for example. The device comprises a signal generator and further a non-permanent attachment means configured to non-permanently (i.e. removably) attach the device to a surface of the bearing, i.e. any part of the bearing, such as a rotating or non-rotating ring, such as an inner ring or outer ring, or part of a bearing housing, so that at least a part of the signal generator is pressed against the surface of the bearing, i.e. the at least one part of the signal generator makes physical contact with a surface of the bearing to enable reliable measurements to be made. A user of the device may hold or press the device against the surface of the bearing while the device is in use. The expression “non-permanently attach” is intended to mean that the device is not intended to remain attached to the bearing in the same position during the operational lifetime of the AE sensor.

Such a device, that simulates an acoustic signal generated by a bearing being monitored, may be used to reliably and repeatedly test whether the signal picked up by an AE sensor is truly representative of the signal emitted by the device, i.e. whether the signal picked up by the AE sensor has the same frequency and/or amplitude and/or pulse period as the signal emitted by the device, and thereby check whether an AE sensor is working correctly. The device may be used to test or calibrate/re-calibrate an AE sensor, or to test whether an AE sensor has been correctly installed. The device may also be used to determine the optimum location of an AE sensor by determining the AE sensor location(s) at which the best (least noisy) signals are picked up by the AE sensor. The device may also be used to determine when it is necessary or desirable to service, re-calibrate or replace an AE sensor that is monitoring a bearing.

According to an embodiment of the invention the signal generator is arranged to emit at least one signal, such as a uni-polar pulse signal, having a predetermined frequency and/or amplitude and/or pulse period.

According to another embodiment of the invention the device may comprise non-permanent attachment means, such as magnetic attachment means configured to magnetically attach the device to the bearing. The magnetic attachment means may be configured to be flush with a surface of the device whereby the device surface is arranged to be pressed against the surface of the bearing when the device is non-permanently attached to the bearing.

According to a further embodiment of the invention the device comprises signal parameter selection means configured to enable a user to change the parameters of the signal(s) emitted by the signal generator. In such “variable mode operation” a user may for example change the frequency and/or amplitude and/or pulse period, and/or some other parameter of a signal emitted by the signal generator. A device according to the invention may however be configured to operate in “fixed mode operation” whereby the same signal is always emitted by the device, i.e. factory default settings are used.

According to an embodiment of the invention the device is configured to be powered by at least one battery.

According to a further embodiment of the invention the device comprises display means, whereby data concerning any signal emitted by the signal generator and/or any other data may be shown to a user of the device.

According to an embodiment of the invention the bearing is a rolling element bearing. The rolling bearing may however be any type of bearing, such as a cylindrical roller bearing, a spherical roller bearing, a toroidal roller bearing, a taper roller bearing, a conical roller bearing or a needle roller bearing.

The present invention also concerns a method for testing an acoustic emission sensor that is configured to monitor a bearing. The method comprises the steps of: non-permanently attaching a portable device comprising a signal generator and non-permanent attachment means configured to non-permanently attach the device to a surface of the bearing so that at least a part of the signal generator is pressed against the surface of the bearing, emitting at least one signal having a predetermined frequency and/or amplitude and/or pulse period, analyzing the at least one signal picked up by the acoustic emission sensor, and removing the portable device from the bearing.

A device according to any of the embodiments of the invention may be used in such a method.

According to an embodiment of the invention the method comprises the step of determining the amount of acoustic signal gain that the acoustic emission sensor is capable of measuring.

The device and method according to the present invention may be used to monitor at least one bearing used in automotive, aerospace, railroad, mining, wind, marine or metal producing applications, or in any other machine applications which require bearings with high wear resistance and/or increased fatigue and tensile strength.

### BRIEF DESCRIPTION OF THE DRAWINGS

The present invention will hereinafter be further explained by means of non-limiting examples with reference to the appended schematic figures where;

FIG. 1 shows a device according to an embodiment of the invention,

FIG. 2 shows a top view of a device according to another embodiment of the invention,

FIG. 3 is a flow diagram showing the steps of a method according to an embodiment of the invention, and

FIG. 4 shows a rolling element bearing that can be monitored using a device or method according to an embodiment of the invention.

It should be noted that the drawings have not necessarily been drawn to scale and that the dimensions of certain features may have been exaggerated for the sake of clarity.

Furthermore, any feature of one embodiment of the invention can be combined with any other feature of any other embodiment of the invention as long as there is no conflict.

### DETAILED DESCRIPTION OF EMBODIMENTS

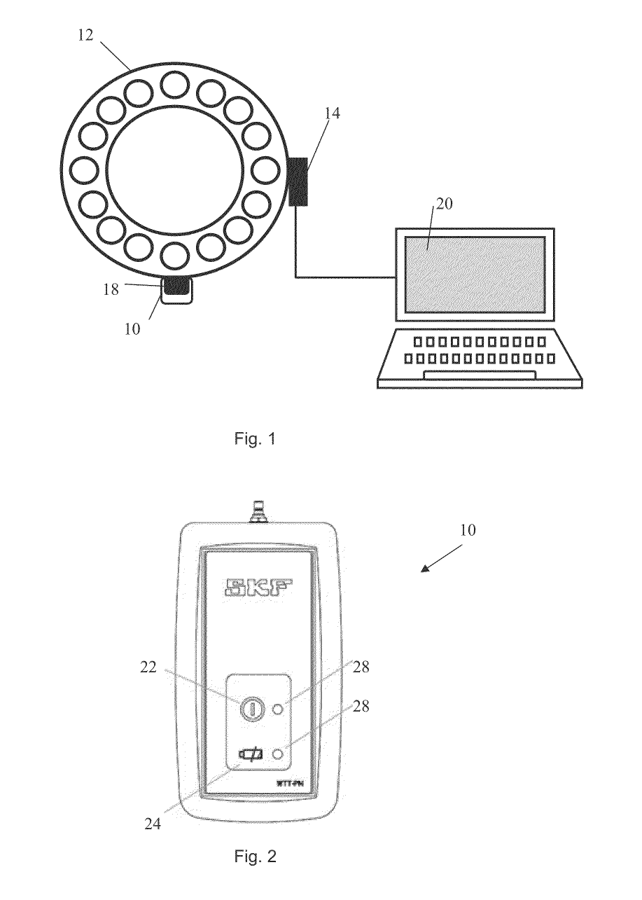

FIG. 1 shows a portable device 10 for testing an acoustic emission sensor 14 that is configured to monitor a bearing 12. The device 10 comprises a signal generator 18 and non-permanent attachment means 16 (shown in FIG. 2) configured to non-permanently attach the device to any suitable surface of the bearing 12 so that at least a part of the signal generator 18 is pressed against the surface of the bearing 12.

The signal generator 18 is arranged to emit at least one signal having a predetermined frequency and/or amplitude and/or pulse period. According to an embodiment of the invention the signal generator 18 may be arranged to emit a 20 volt peak AC signal with a 70 Hertz frequency, with a pulse period of 2.0 μs. The signal generator 18 may use an Olympus V101 acoustic transducer. A coaxial cable may be used to couple the signal generator 18 output signal with an acoustic transducer.

The signal picked up by the acoustic emission sensor 14 being tested may then be analyzed. In the illustrated embodiment signals from the AE sensor 14 being tested may be analyzed using a computer.

The device 10 may comprise signal parameter selection means configured to enable a user to change the parameters of the signal(s) emitted by the signal generator 18, the device 10 may be battery-powered and/or it may comprise a display means (not shown). The device 10 may have a battery power-saving feature whereby the device 10 is configured to automatically switch itself off after a predetermined time, such as after 60 minutes, if the device 10 has not been used during that time period. The device 10 may be configured to allow a user to select and change this predetermined automatic switch off time.

The device 10 comprises a signal generator 18. The signal generator 18 comprises at least a part the is arranged on the outside of the outer housing 10h of the device 10 or in the vicinity thereof so that it can be pressed against a surface of a bearing 12 to which the device 10 is attached to enable reliable measurements to be made.

The device 10 may comprise a protective sheath, comprising rubber or any other suitable material, as part of, or in addition to, its outer housing 10h. The device 10, the outer housing 10h or the protective sheath may comprise a stand and/or belt clip.

A device 10 according to the present invention may comprise one or more visual, acoustic and/or tactile means to indicate that the device 10 is receiving power, or switched on, or that the signal generator 18 of the device 10 is emitting a signal or that its battery power is low. The device 10 may comprise a light emitting diode, LED to indicate that the device 10 is switched on and ready to be used.

It should be noted that the device 10 may be of any suitable shape. As regards the size, the device 10 may have a length of 100-200 mm, a width of 30-70 mm and a height of 5-40 mm so as to ensure that it may easily be held in the hand of a user.

FIG. 2 shows the top of a device according to an embodiment of the invention. The device 10 comprises an on/off button 22, a symbol indicating remaining battery power 24, and two LEDs 28 indicating when the device is switched on, and when battery power is low respectively.

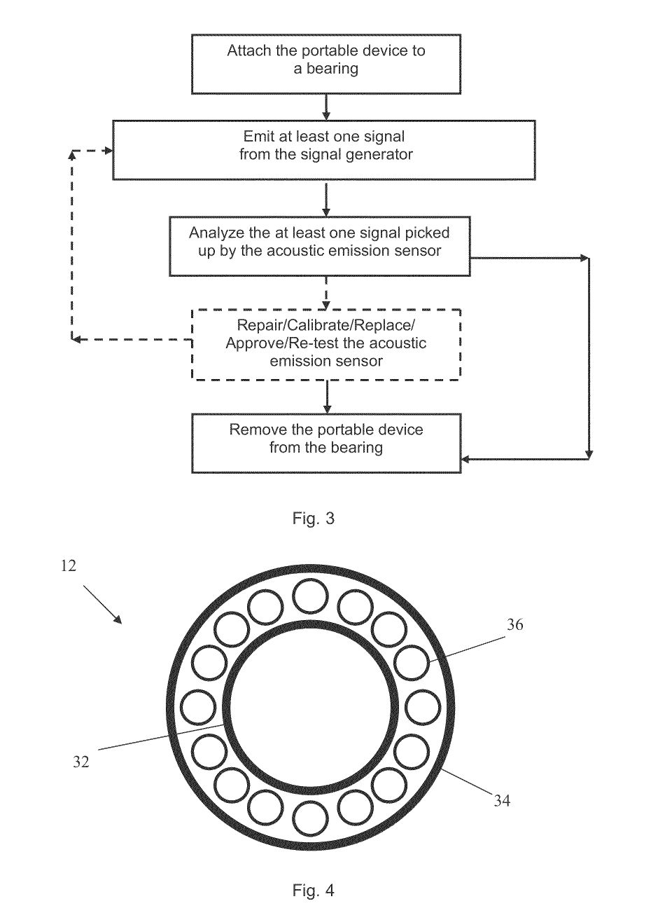

FIG. 3 shows a method according to an embodiment of the invention. The method comprises the steps of a) non-permanently attaching a portable device 10 according to any of the embodiments of the invention to any surface of a bearing 12 so that at least a part of the signal generator 18 of the device 10 is pressed against the surface of the bearing 12, b) emitting at least one signal having a predetermined frequency and/or amplitude, c) analyzing the at least one signal picked up by the acoustic emission sensor 14 and d) removing the portable device 10 from the bearing 12. The acoustic emissions sensor 14 may be repaired, replaced, approved, re-tested or the signal strength pickup of the AE sensor 14 may be calibrated/re-calibrated after the analysis has been conducted depending on the results of the analysis of the at least one signal picked up by the acoustic emission sensor 14. The device 12 may then be used to test another AE sensor or to test the same AE sensor 14 by mounting the device 10 on another part of the same bearing 12.

The surface of a bearing 12, such as a metal surface of the bearing 12 should be cleaned before the device 10 is non-permanently attached thereto. For example, all dust, residue and/or paint may be removed using sandpaper and surface cleaner (IPA) to ensure direct contact with the surface of the bearing 12.

Acoustic couplant gel, grease or oil may be placed between the device 10 and the surface of the bearing 10 to which it is non-permanently attached to improve acoustic signal transmission therebetween. At least one signal emitted by the signal generator 18 may be injected into the bearing 12 in the vicinity of an acoustic emission sensor 14 being tested.

When injecting a signal into the surface of the bearing 12 it should be ensured that there is a direct transmittance path between the acoustic emission sensor 14 and the signal generator 18. There should be no cracks, joints, nuts, bolts, holes etc. interrupting the transmission path.

If an acoustic emission sensor 14 is mounted on the inner ring of a sensor then a device according to an embodiment of the invention may be non-permanently attached in the following locations: a) immediately adjacent to the acoustic emission sensor in an axial direction to the inner ring, b) at a position 90° along the inner ring in an axial direction, c) at a position 180° along the inner ring in an axial direction.

According to an embodiment of the invention the method comprises the step of determining the amount of acoustic signal gain that the acoustic emission sensor 14 is capable of measuring.

FIG. 4 schematically shows an example of bearing 12 that can be monitored using an acoustic emission sensor 14 that may be tested using the device 10 or method according to an embodiment of the invention. FIG. 4 shows a rolling element bearing 12 comprising an inner ring 32, an outer ring 34 and a set of rolling elements 36. The inner ring 32 and/or outer ring 34 of a bearing 12 may be of any size and have any load-carrying capacity. An inner ring 32 and/or an outer ring 34 may for example have a diameter up to a few meters and a load-carrying capacity up to many thousands of tonnes.

A device 10 according to the present invention may be non-permanently attached to any surface of the bearing 12, preferably a flat, clean and smooth surface of the bearing. For example, the signal generator 18 of the device 10 may be pressed against the surface of the bearing 12 to inject a signal into it and held in place until at least one, and preferably a plurality of data samples of the system response have been recorded.

Further modifications of the invention within the scope of the claims would be apparent to a skilled person. Even though the claims are directed to a device and method for testing an acoustic emission sensor for monitoring a bearing, such a device and method may be used to test any acoustic emission sensor.

1. A device for testing an acoustic emission sensor that is configured to monitor a bearing, the device comprising a signal generator,
wherein the device is portable, being arranged to be non-permanently attached to a surface of the bearing in a manner wherein at least a part of the signal generator is pressed against the surface of the bearing.

2. The device according to claim 1, wherein the signal generator is arranged to emit at least one signal having at least one of a predetermined frequency, a predetermined amplitude and a predetermined pulse period.

3. The device according to claim 1, further comprising a signal parameter selection element configured to enable a user to change the parameters of the at least one signal emitted by the signal generator.

4. The device according to claim 1, wherein the device is configured to be powered by at least one battery.

5. The device according to claim 1, further comprising a display device.

6. A method for testing an acoustic emission sensor that is configured to monitor a bearing, the method comprising steps of:
a) non-permanently attaching a portable device comprising a signal generator to a surface of the bearing so that at least a part of the signal generator is pressed against the surface of the bearing;
b) emitting at least one signal having a predetermined frequency and/or amplitude;
c) analyzing the at least one signal picked up by the acoustic emission sensor; and
d) removing the portable device from the bearing.

7. The method according to claim 6, the method further comprising a step of determining an amount of acoustic signal gain that the acoustic emission sensor is capable of measuring.

8. A device according to claim 1, wherein the signal generator is arranged to emit at least one signal having fixed parameters.

9. A device according to claim 1, wherein the signal generator is arranged to emit at least one signal having fixed parameters,
wherein the device is configured to operate in fixed mode operation.
